(19) United States
(12) Patent Application Publication
(10) Pub. No.: US 2010/0155987 A1
(43) Pub. Date: Jun. 24, 2010

(54) METHOD AND GASKETS FOR CASTING ACRYLIC FILMS

(76) Inventors: Woo-Sung Kim, Daejeon Metropolitan City (KR); Won-Kook Kim, Daejeon Metropolitan City (KR); Young-Jun Hong, Daejeon Metropolitan City (KR); Yang-Gu Kang, Daejeon Metropolitan City (KR); Hyeon Choi, Daejeon Metropolitan City (KR); Dong-Joo Kwon, Daejeon Metropolitan City (KR); Jee-Seon Kim, Seoul (KR)

Correspondence Address: MCKENNA LONG & ALDRIDGE LLP, 1900 K STREET, NW, WASHINGTON, DC, 20006, US

(21) Appl. No.: 12/733,282

(22) PCT Filed: Aug. 21, 2008
(86) PCT No.: PCT/KR2008/004875

§ 371 Date: Feb. 22, 2010

(30) Foreign Application Priority Data
Aug. 23, 2007 (KR) 2007-0084994

(51) Int. Cl. B29D 7/01; B29C 39/32

(52) U.S. Cl. 264/213; 264/216; 249/134

(57) ABSTRACT

The present invention relates to a method for casting an acryl film, which includes the steps of injecting a material of the acryl film into a space that is formed from a pair of substrates and a gasket positioned between a pair of substrates, and curing the material of the acryl film. The shrinkage ratio of the gasket is not less than 10% after the acryl film is subjected to the curing step, or the shrinkage ratio of the gasket after the acryl film is subjected to the curing step is the same as or larger than the shrinkage ratio of the material of the acryl film.

### TECHNICAL FIELD

The present invention relates to a method and a gasket for casting an acryl film. More particularly, the present invention relates to a method and a gasket for casting an acryl film that has a thickness of not more than 1 mm. This application claims priority from Korean Patent Application No. 10-2007-0084994 filed on Aug. 23, 2007 in the KIPO, the disclosure of which is incorporated herein by reference in its entirety.

### BACKGROUND ART

As shown in FIGS. 1 and 2, a general casting method of an acryl film is carried out by adding a soft or hard gasket for controlling the thickness of the acryl film between two cell casting plates made of glass and the like, sealing it, filling the polymerization raw material, curing it in a constant temperature water bath or an oven, and separating the film.

There is no problem in that a film having the thickness of more than 1 mm is produced by using the casting method as described above, but when a thin type film having the thickness of not more than 1 mm is produced, there are problems in that wrinkles are formed on the film while it is cured or the film is deformed by a change in flatness of the film surface. In particular, as the material for forming the acryl film, in the case of when only the monomer is directly injected into a mold to perform the casting, the film is polymerized and cured to shrink more in comparison with the case of when a polymer syrup that is dissolved in a small amount of monomer is used, thus it is difficult to accomplish the uniformity of the thickness. However, in the case of when the film is shaped by using the monomer, since there is an advantage in that the density of the film may be increased in comparison with the case of when the polymer is used, there is a need to develop a technology for producing a film having the thickness of not more than 1 mm by using the monomer without the above problems.

### DISCLOSURE

### Technical Problem

In order to solve the above problems, the present inventors have conducted extensive studies into the prevention of deformation of the film when the thin type acryl film is produced by using a casting method, and as a result, it was found that by controlling the shrinkage ratio of the gasket which is a constitution element of a casting mold, a thin type acryl film may be produced so that a predetermined thickness and flatness are ensured.

Therefore, it is an object of the present invention to provide a method and a gasket for casting a thin type acryl film having a flat surface and a predetermined thickness.

### Technical Solution

The present invention provides a method for casting an acryl film, which includes the steps of injecting a material of the acryl film into a space that is formed from a pair of substrates and a gasket positioned between the pair of substrates, and curing the material of the acryl film. The shrinkage ratio of the gasket after the acryl film is subjected to the curing step is not less than 10%.

In addition, the present invention provides a method for casting an acryl film, which includes the steps of injecting a material of the acryl film into a space that is formed from a pair of substrates and a gasket positioned between the pair of substrates, and curing the material of the acryl film. The shrinkage ratio of the gasket after the acryl film is subjected to the curing step is the same as or larger than the shrinkage ratio of the material of the acryl film.

In addition, the present invention provides a gasket for casting, in which while an acryl film is cast, a shrinkage ratio after curing is not less than 10%.

In addition, the present invention provides a gasket for casting an acryl film, in which while an acryl film is cast, a shrinkage ratio after curing is the same as or larger than the shrinkage ratio of the material of the acryl film.

### ADVANTAGEOUS EFFECTS

In the present invention, when an acryl film is produced by using a casting method, a thin type acryl film that has a thickness of not more than 1 mm may be produced so that a predetermined thickness and flatness are ensured by controlling the shrinkage ratio of the gasket which is a constitution element of a mold.

### DESCRIPTION OF DRAWINGS

FIG. 1 is an exploded perspective view that illustrates the arrangement order of two substrates and a gasket that is positioned between the two substrates in order to cast an acryl film.

FIG. 2 is a cross sectional view illustrates the layering state of two substrates and a gasket that is positioned between the two substrates in order to cast an acryl film.

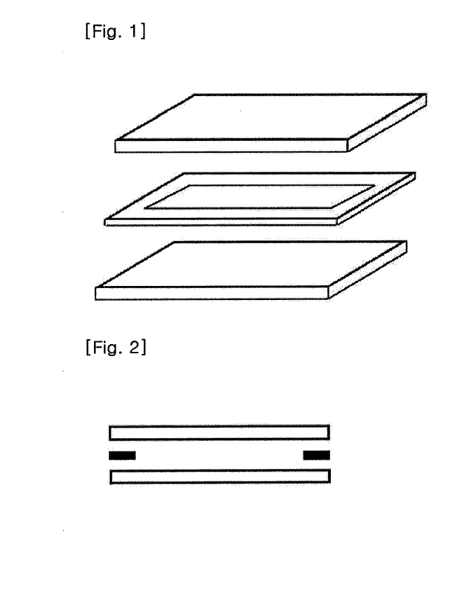

### BEST MODE

Hereinafter, the present invention will be described in detail.

In the present invention, the shrinkage ratio of a gasket is on the basis of the volume of the gasket, and it is particularly preferable that the gasket is well shrunken in a thickness direction.

In the present invention, by controlling a pair of substrates that act as a mold of the film while the acryl film is cast and the shrinkage ratio of the gasket, the thin type acryl film that has a thickness of not more than 1 mm may be produced so that the surface is flat and a predetermined thickness is ensured.

According to an embodiment of the present invention, as the gasket, a gasket that has a shrinkage ratio of not less than 10% after the curing step may be used. In detail, the acryl film is cured and produced through a radical polymerization in a closed state in which an inflow of external air is stopped. In the curing step, the shrinkage of the acryl occurs, and in a current process system, the shrinkage of about 10% occurs. In the case of the thin type acryl film that has a thickness of not more than 1 mm, if the shrinkage of acryl as described above is not compensated by the shrinkage ratio of the gasket, wrinkles are formed on the surface of the film. Therefore, by using the gasket that has the shrinkage ratio of not less than 10%, the acryl film that has the excellent surface state and the thickness of not more than 1 mm may be obtained. However, if the gasket that has the shrinkage ratio of more than 50% is used, by penetrating air bubbles contained in the gasket between acryl molecules in the polymerization, the acryl polymerization may be reduced, and by inflow paths of the bubbles are formed on the surface of the acryl, the surface defects may be formed. In addition, the acryl monomer may be lost.

According to another embodiment of the present invention, as the gasket, a gasket that has the shrinkage ratio after the curing step, that is the same as or larger than that of the material of the acryl film is used. The reason is because when the cured acryl sheet is cured, vacuum pressure occurs in a space while the shrinkage occurs, which is applied to the upper and the lower glass plate as an attractive force. If the shrinkage ratio of the gasket is smaller than the shrinkage ratio of the material of the acryl film, since the space between the glass plates is shrunken like a parabola, there are problems in that the thickness of the film is reduced as come closer to the center. Accordingly, in the present invention, by using the gasket that has the shrinkage ratio that is the same as or larger than the shrinkage ratio of the material of the acryl film, the acryl film that has the excellent surface state and the predetermined thickness of not more than 1 mm may be obtained. At this time, the shrinkage ratio of the gasket used is 1 to 10 times as large as that of acrylate.

In the present invention, as the material of the acryl film, a material that is known in the art may be used, and a polymer or a monomer may be used. In the case of when the acryl film is produced by using the monomer according to a casting method, there is an advantage in that the density of the film may be increased. On the other hand, if a known technology is used, a thin type acryl film that has a flat surface and a predetermined thickness may not be obtained. However, in the method of the present invention, in the case of when the monomer is used as the material of the acryl film, the density of the film may be increased and a thin type film that has a flat surface and a predetermined thickness may be obtained.

In detail, as the material of the acryl film, an acryl-based monomer, for example, acrylate such as methyl acrylate, and ethyl acrylate; methacrylate such as methyl methacrylate and ethyl methacrylate; an acrylic acid or a methacrylic acid; a bisphenol A-based acrylate monomer; and polyalkylene glycol-based di(metha)acrylate may be used, and a mixture thereof may be used. In addition, as the multifunctional acrylate monomer, dipentaerythritol hexaacrylate (DPHA), dipentaerythritol hydroxy pentaacrylate, pentaerythritol tetraacrylate, pentaerythritol triacrylate, trimethylene propyl triacrylate (TMPTA), propoxylated glycerol triacrylate, trimethylpropane ethoxy triacrylate, or a mixture thereof may be used.

As the bisphenol A-based acrylate monomer, it is preferable to use di(metha)acrylate, and in detail, there are BP4PA and the like.

As the polyalkylene glycol-based di(metha)acrylate, for example, bisphenol A ethoxylate di(metha)acrylate that includes an ethoxy group of 2 to 20 repeating units, bisphenol A propoxylate di(metha)acrylate that includes a propoxy group of 2 to 20 repeating units, bisphenol A alkoxylate di(metha)acrylate that includes an epoxy group and a propoxy group of 2 to 20 repeating units, bisphenol A glycerollate dimethacrylate, bisphenol A glycerollate (1 glycerol/phenol) dimethacrylate, or a mixture thereof may be used.

In the present invention, as the material of the acryl film, it is preferable that a bisphenol A-based acrylate monomer, a polyalkylene glycol-based di(metha)acrylate or a mixture thereof is used. In addition, as a detailed monomer, it is preferable that BP4PA, EGDA (ethylene glycol diacrylate), EGDMA (ethylene glycol dimethacrylate), DPHA (dipentaerythritol hexaacrylate), and TMPTA (trimethylene propyltriacrylate) are used. In the present invention, to the acryl-based monomer, unsaturated hydrocarbon that includes an aromatic ring, for example, styrene, divinyl benzene and the like, may be further added.

To the material of the acryl film, additives that are known in the art may be added within a range in which physical properties for the final purpose are not obstructed. For example, to the material of the acryl film, a polymerization initiator, a stabilizer, a UV absorbing agent, an antioxidant, a chain transferring agent and the like may be added. In detail, in order to polymerize the material of the acryl film, an azo-based polymerization initiator such as 2,2′-azobis isobutyronitrile, 2,2′-(2,4-dimethyl isovaleronitril), 2,2′-azobis(4-methoxy-2,4-dimethyl valeronitrile), 1,1′-azobis(cyclohexane 1-carbonitrile) and the like, or a peroxide-based polymerization initiator such as lauroyl peroxide, methyl ethyl keton peroxide, diisopropyl peroxy dicarbonate, dicyclohexane peroxydicarbonate and the like may be used. As the antioxidant, as a radical scavenger, there are phenol types, hydroxylamine types, lactone types and the like, and as the UV absorbing agent, triazine types, benzotriazole types, benzophenone types and the like. As the stabilizer, there is a hindered amine light stabilizer. In addition to this, the IR absorbing agent, an antifoaming agent, an antistatic agent, a release agent and the like may be added if necessary.

In the present invention, the material of the gasket is not particularly limited as long as it is not dissolved in the material of the acryl film and has the shrinkage ratio as described above according to the curing. For example, foamed polyethylene, foamed polyvinyl chloride, foamed PDMS (polydimethylsiloxanes), foamed polystyrene, foamed urethane and the like may be used. The gasket may have a hollow shape, or may be filled. In addition, its section may be circle, rectangular, or trapezoidal, and it may have a conical shape. Those who are skilled in the art may determine the thickness of the gasket according to the desired thickness of the film, and the size of the gasket may be determined according to the desired size of the film.

In the present invention, the material of the substrate may be used without a limitation as long as it is known in the art. For example, glass, metal, plastic substrates may be used, but the glass is most preferable. In addition, the substrate may have the flat surface, but if necessary have a specific shape on the surface thereof. The preferable thickness of the substrate depends on the size and the kind of the substrate, and when the gasket and the substrate are attached to each other, it should have the thickness enough to prevent the bending of the substrate. For example, in the case of the glass substrate that has the area of 1 m², it is preferable that the thickness is not less than 5 mm.

If necessary, adhesive film (or sheet) for attaching the gasket and the substrate may be provided between the gasket and the substrate, or a sealing film for sealing the gasket and the substrate may be used.

In the present invention, before the material of the acryl film is further injected, a surface release agent is coated on the surfaces of the gasket and the substrate, or the surface release agent may be added to the material of the acryl film. As the surface release agent, PDMS (polydimethyl siloxanes), polysiloxane polyether copolymers, fluorine-based surface treating agents and the like may be used.

In the present invention, the condition for curing the material of the acryl film is the same as the following description. The curing starts under the normal pressure condition at 25° C. and its temperature is gradually increased for 2˜5 hours to 100° C. After it is maintained at 100° C. for 1˜3 hours, the temperature is reduced for 2˜5 hours to 25° C. to cure the film. However, the scope of the present invention is not limited by the above condition, but a curing condition that is known in the art may be used.

The method according to the present invention may further include after the curing step, separating the substrate and the gasket and separating the acryl film.

According to the method of the present invention, the film that has the size of not less than 20 cm×20 cm may have the thickness of not more than 1 mm, preferably 0.1 to 0.5 mm, and more preferably about 0.3 mm. In addition, the film that is produced according to the present invention has a small thickness deviation. The thickness deviation is different from each other according to the purpose of the film, but the thickness deviation is preferably not more than 30%, and more preferably less than 10%.

The present invention provides a gasket for performing the above method. According to an embodiment of the present invention, there is provided a gasket for casting of the acryl film that is characterized in that the shrinkage ratio after the curing of the acryl film in the casting is not less than 10%. According to another embodiment of the present invention, there is provided a gasket for casting of the acryl film that is characterized in that the shrinkage ratio after the curing of the acryl film in the casting is the same as or larger than the shrinkage ratio of the material of the acryl film.

### MODE FOR INVENTION

Herein below, the present invention will be described in detail with reference to Examples. The present invention may, however, be embodied in many different forms and should not be construed as being limited to the Examples set forth herein. Rather, these Examples are provided to fully convey the concept of the invention to those skilled in the art.

### EXAMPLE

In the following Examples, monomers that are described in the following Table 1 were used as materials of the acryl film.

TABLE 1

| | | Composition |
|---|---|---|
| | Component | ratio (wt %) |
| Acrylate | Bisphenol-based di(metha)acrylate | 80.00 |
| | (BP4PA manufactured by KYOEISHA, | |
| | Co., Ltd.) | |
| | Multifunctional acrylate (9-EGDA | 15.00 |
| | manufactured by KYOEISHA, Co., Ltd.) | |
| Initiator | V65 (WACKO) | 0.20 |
| Stabilizer | HALS (hindered amine light stabilizer) | 4.00 |
| | [Tinuvin 144 (Ciba)] | |
| | UVA [Tinuvin 400 (Ciba)] | 0.80 |
| Total | | 100.00 |

### Example 1

The gasket that was made of foamed PVC (polyvinyl chloride) that had the shrinkage ratio of 20% showing the thickness change from 500 to 400 μm while it was cured under the vacuum compression was used to cast the acryl film. In detail, between two glass substrates that had the size of 20 CM×30 CM, the gasket that is made of the foamed PVC was put, the composition including the material of Table 1 was injected, and the curing was carried out. At this time, the shrinkage ratio of the material of the acryl film that was produced by using the composition including the material of Table 1 was 11%. The curing was carried out under the following condition. The curing started under the normal pressure condition at 25° C. and its temperature was gradually increased for 4 hours to 100° C. After it was maintained at 100° C. for 2 hours, the temperature was reduced for 4 hours to 25° C. After the curing step, the thickness deviation of the acryl film that was separated from the substrate and the gasket was within 5%, and the thickness was in the range of 395 to 410

### Example 2

The acryl film was produced in the same manner as Example 1, except that foamed PE (polyethylene) that had the shrinkage ratio of 25% showing the thickness change from 400 to 300 μm under the vacuum compression in the curing was used as the gasket. After the curing step, the thickness deviation of the acryl film that was separated from the substrate and the gasket was within 8%, and the thickness was in the range of 305 to 330 μm.

### Comparative Example 1

The acryl film was produced in the same manner as Example 1, except that PC (polycarbonate) that had the shrinkage ratio of less than 0.1% under the vacuum compression in the curing and the thickness of 300 μm was used as the gasket. After the curing step, the thickness deviation of the acryl film that was separated from the substrate and the gasket was within 60%, and the thickness was in the range of 250 to 400 μm.

### Comparative Example 2

The acryl film was produced in the same manner as Example 1, except that PVC (polyvinyl chloride) that had the shrinkage ratio of less than 0.1% under the vacuum compression in the curing and the thickness of 300 μm was used as the gasket. After the curing step, the thickness deviation of the acryl film that was separated from the substrate and the gasket was within 56%, and the thickness was in the range of 180 to 350 μm.

In the case of when the acryl film is produced by using the casting method according to the present invention, by controlling the shrinkage ratio of the gasket which is a constitution element of a mold, a thin type acryl film having a thickness of not more than 1 mm may be produced so that a predetermined thickness and flatness are ensured.

1. A method for casting an acryl film, comprising the steps of:
injecting a material of the acryl film into a space that is formed from a pair of substrates and a gasket positioned between the pair of substrates; and
curing the material of the acryl film,
wherein the shrinkage ratio of the gasket after the acryl film is subjected to the curing step is not less than 10%.

2. The method for casting an acryl film as set forth in claim 1, wherein the shrinkage ratio of the gasket after the acryl film is subjected to the curing step is in the range of 10% to 50%.

3. The method for casting an acryl film as set forth in claim 1, wherein the thickness of the acryl film is not more than 1 mm.

4. The method for casting an acryl film as set forth in claim 1, wherein the material of the acryl film is one selected from the group consisting of (metha)acrylic acid ester, (metha)acrylic acid, bisphenol A-based acrylate, polyalkylene glycol-based di(metha)acrylate and multifunctional acrylate, or a mixture thereof.

5. The method for casting an acryl film as set forth in claim 1, wherein the material of the acryl film includes one or more additives selected from the group consisting of a polymerization initiator, a stabilizer, a ultraviolet-absorbing agent, an antioxidant, a chain transfer agent, an IR absorbent, an antifoaming agent, an antistatic agent and a surface release agent.

6. The method for casting an acryl film as set forth in claim 1, wherein the gasket is made of one or more materials selected from the group consisting of foamed polyethylene, foamed polyvinyl chloride, foamed PDMS (polydimethyl siloxanes), foamed polystyrene and foamed urethane.

7. The method for casting an acryl film as set forth in claim 1, wherein the pair of substrates are made of glass, metal or a plastic material.

8. The method for casting an acryl film as set forth in claim 1, wherein the curing step is carried out by gradually increasing the temperature from 25° C. to 100° C. under normal pressure for 2˜5 hours, maintaining at 100° C. for 1˜3 hours, and reducing the temperature for 2˜5 hours to 25° C.

9. The method for casting an acryl film as set forth in claim 1, further comprising:
before the material of the acryl film is injected, coating a surface release agent on the surfaces of the gasket or at least one substrate.

10. A method for casting an acryl film, comprising the steps of:
injecting a material of the acryl film into a space that is formed from a pair of substrates and a gasket positioned between the pair of substrates; and
curing the material of the acryl film,
wherein the shrinkage ratio of the gasket after the acryl film is subjected to the curing step is the same as or larger than the shrinkage ratio of the material of the acryl film.

11. The method for casting an acryl film as set forth in claim 10, wherein the shrinkage ratio of the gasket after the acryl film is subjected to the curing step is 1 to 10 times as large as the shrinkage ratio of the material of the acryl film.

12. The method for casting an acryl film as set forth in claim 10, wherein the thickness of the acryl film is not more than 1 mm.

13. The method for casting an acryl film as set forth in claim 10, wherein the material of the acryl film is one selected from the group consisting of (metha)acrylic acid ester, (metha)acrylic acid, bisphenol A-based acrylate, polyalkylene glycol-based di(metha)acrylate and multifunctional acrylate, or a mixture thereof.

14. The method for casting an acryl film as set forth in claim 10, wherein the material of the acryl film includes one or more additives selected from the group consisting of a polymerization initiator, a stabilizer, a ultraviolet-absorbing agent, an antioxidant, a chain transfer agent, an IR absorbent, an antifoaming agent, an antistatic agent and a surface release agent.

15. The method for casting an acryl film as set forth in claim 10, wherein the gasket is made of one or more materials selected from the group consisting of foamed polyethylene, foamed polyvinyl chloride, foamed PDMS (polydimethyl siloxanes), foamed polystyrene and foamed urethane.

16. The method for casting an acryl film as set forth in claim 10, wherein the pair of substrates are made of glass, metal or a plastic material.

17. The method for casting an acryl film as set forth in claim 10, wherein the curing step is carried out by gradually increasing the temperature from 25° C. to 100° C. under normal pressure for 2˜5 hours, maintaining at 100° C. for 1˜3 hours, and reducing the temperature for 2˜5 hours to 25° C.

18. The method for casting an acryl film as set forth in claim 10, further comprising:
before the material of the acryl film is injected, coating the surface release agent on the surfaces of the gasket or at least one substrate.

19. A gasket for casting, characterized in that a shrinkage ratio after curing is not less than 10%, in the course of the casting of the acryl film.

20. A gasket for casting, characterized in that a shrinkage ratio after curing is the same as or larger than the shrinkage ratio of the material of the acryl film, in the course of the casting of the acryl film.
